(19) United States
(12) Patent Application Publication
(10) Pub. No.: US 2011/0308136 A1
(43) Pub. Date: Dec. 22, 2011

(54) FISHING BOBBER

(76) Inventor: Gary Dragony, Mountain View, CA (US)

(21) Appl. No.: 12/818,994

(22) Filed: Jun. 18, 2010

(51) Int. Cl. A01K 93/00

(52) U.S. Cl. 43/43.11; 43/44.87; 43/43.1

(57) ABSTRACT

A fishing bobber having electronic circuitry coupled to an electro-mechanical device. The electro-mechanical device is to affect a depth of a hook beneath the bobber by inducing movement of a fishing line that is coupled to the hook and threaded through the bobber. The electronic circuitry has wireless receiver circuitry to receive a wireless command that causes the electro-mechanical device to take action in response thereto.

### BACKGROUND

Fishing bobbers are used to control the depth at which a hook resides beneath the surface of the water. FIG. 1 shows a typical situation. As observed in FIG. 1, the fishing bobber 101 is a flotation device to which the fishing line 102 is attached. By controlling the length 103 of the fishing line 102 beneath the bobber 101, the depth of the hook 104 beneath the water surface 105 is controlled. Thus, for example, if a fisherman believes fish are one foot beneath the water's surface, length 103 is set to a distance of approximately one foot.

A problem with commonly used fishing bobbers, however, is that the hook and bobber become more and more difficult to cast as length 103 increases. Here, length 103 is established before the bobber and hook are cast into the water (e.g., by tying the fishing line to the bobber 101). Casting the bobber and hook is typically accomplished by “whipping” the fishing pole tip toward their desired destination in the water. With an open reel and the bobber and hook attached to the fishing line, the “whip” of the fishing pole tip in combination with the weight of the bobber and hook (and any leader/weight and/or bait) casts the bobber and hook over the water to their desired destination. Here, if length 103 is too long, the combined weight of the bobber and hook is too dispersed over the fishing line resulting in, for instance, a cast bobber but not a cast hook.

Another problem with typical fishing bobbers is that length 103 cannot be changed once the bobber and hook are cast. That is, if a fisherman believes the fish may be at a different depth than what length 103 was originally set to before the cast, the fisherman has no choice but to reel in the line, reset length 103 by hand, and recast.

### FIGURES

The present invention is illustrated by way of example and not limitation in the figures of the accompanying drawings, in which like references indicate similar elements and in which:

FIG. 1 shows a prior art hook and bobber;

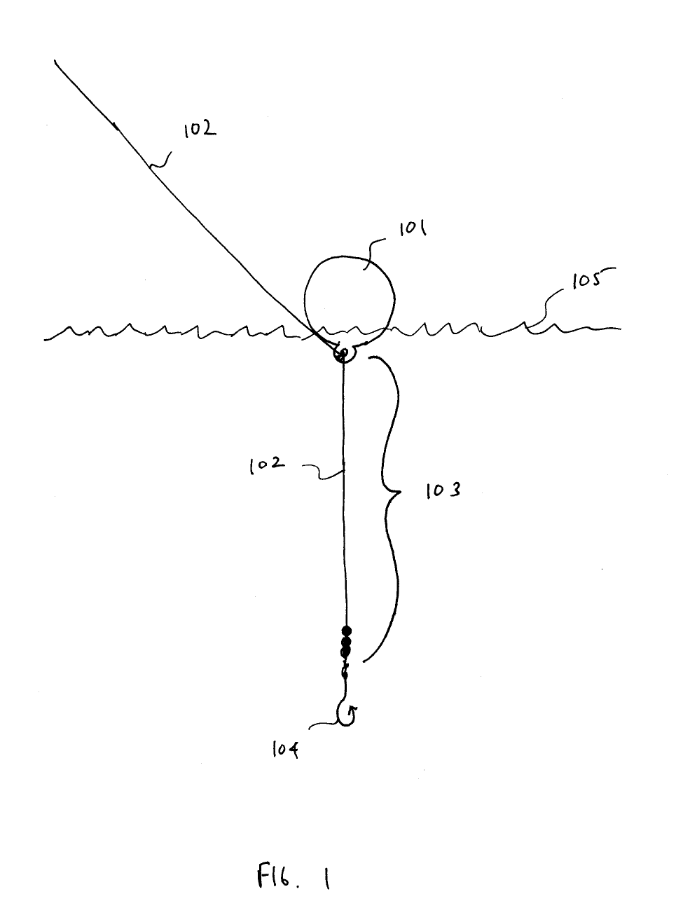

FIGS. 2a and 2b pertain to an improved bobber design;

FIGS. 3a through 3g show various improved bobber design embodiments;

FIG. 4a through 4c shows a detailed improved bobber design;

FIG. 5 shows an embodiment of electronic circuitry for use within an improved bobber embodiment;

FIG. 6 shows a fishing pole having a transmitter for communicating with the improved bobber;

FIG. 7 shows a second improved bobber design.

### DETAILED DESCRIPTION

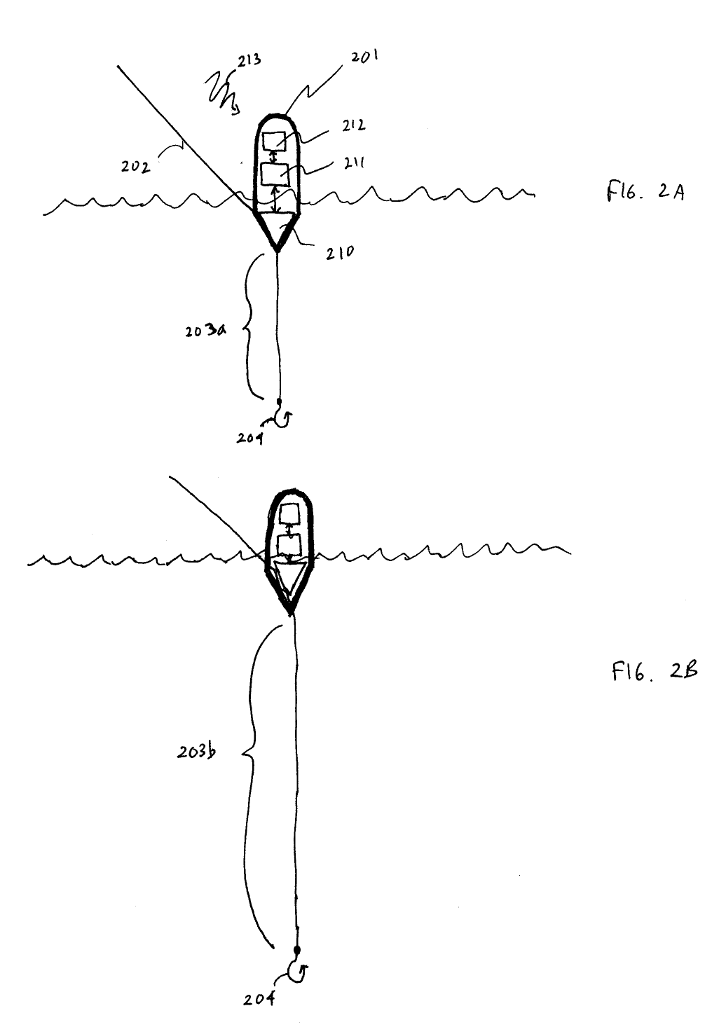

FIGS. 2A and 2B demonstrate an improved bobber design that has the capability to electromechanically adjust the length 203 of the fishing line beneath the bobber. FIG. 2A shows an exemplary fishing bobber 201 having a brake element 210 coupled to an electro-mechanical device 211 which, in turn, is coupled to electronic circuitry 212. As described in more detail below, the electronic circuitry 212 is capable of wirelessly receiving commands to release/lock the brake element 210.

Nominally, when the bobber and hook are cast and in the water and thereafter, the brake element 210 is engaged against the fishing line 202 such that the fishing line 202 is essentially attached to the bobber 201. If the fisherman later decides that the length 203a of the fishing line between the hook 204 and bobber 201 needs to be adjusted, a wireless command 213 is sent (e.g., by a transmitter attached to the fishing pole) to the bobber 201 to release the locking mechanism. The electronic circuitry 212 receives and processes the command and, in response, sends an appropriate signal to the electro-mechanical device 211.

The electro-mechanical device 211, in response to the signal, as observed in FIG. 2B, causes some kind of physical movement of the brake element 210 that releases the fishing line 202 (in the case of FIG. 2B the brake element 210 is pulled upward). With the fishing line in hand and the brake element's release of the fishing line, the fisherman is free to raise or lower the hook 204 relative to the water surface. Once the fisherman has brought in the line to raise the hook to correct (higher) depth, or, has let out the line to lower the hook to the correct (lower) depth 203b, a second wireless command is sent to the bobber 201 to engage the brake element 210 against the fishing line 202 to set the depth of the hook 204 to its new distance 203b beneath the bobber.

Note that although FIGS. 2a and 2b show a conical brake element 210, brake elements of other shapes are also possible (to name a few: cylindrical, square/rectangular, spherical). In the bobber design of FIGS. 2a and 2b, the braking element 210 presses the fishing line 202 against an outer wall of the bobber 201 to clamp the line to the bobber. In alternate embodiments, as described in more detail below, the braking element may press the fishing line against an internal wall, ceiling, floor or other fixture within the bobber, or, may even have multiple moving, oppositely facing brake elements with the fishing line in between that meet one another to pinch the fishing line to engage and move away from one another to release.

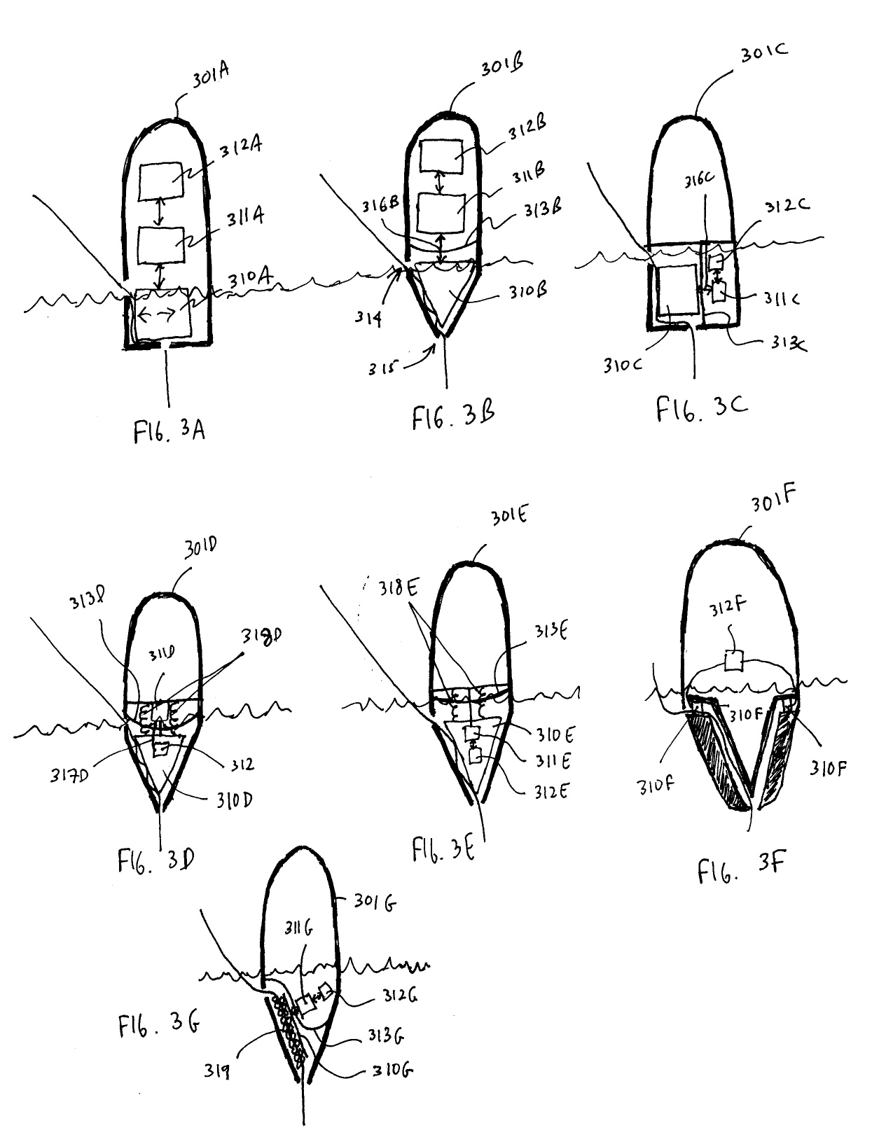

FIGS. 3A-3G show a number of different bobber designs to demonstrate just some of the possible embodiments.

Whereas the electro-mechanical device 211 of FIGS. 2A and 2B moves the brake element 210 up/down relative to the water surface to disengage/engage the fishing line, by contrast, the electro-mechanical device 311A of FIG. 3A moves the braking element left/right along the water surface to engage/disengage the fishing line.

FIG. 3B shows the presence of a water tight seal 313B (which may be flexible or rigid depending on designer preference) to protect the electro-mechanical device 311B and electronic circuitry 312B from water that may enter the bobber as a consequence of the openings 314, 315 in the bobber. The rigid or flexible water tight seal 313B may be made of any of various materials such as plastics, polymers, etc. Notably, a water tight seal may be included in a large number of embodiments including any of the embodiments observed in FIGS. 2A, 2B and FIGS. 3A-3G.

With respect to the particular embodiment observed in FIG. 3B note that the water tight seal includes a water tight seal around the mechanical interface 316B between the electro-mechanical device 311B and the brake element 310B. For example, if the electro-mechanical device 311B is a servo-motor or actuator that moves a post up/down to engage/disengage the brake element 310B with/from the fishing line, the post may be essentially punched through the seal 313B with the seal nevertheless being water proof all around the post. Alternatively, if the seal 313 is flexible, the post may simply press into the seal 313 and the seal—with the downward movement of the post—pushes the brake element 310B down. A spring (not shown) may be compressed or stretched while the brake element is being pushed down which causes a strain that naturally pushes the brake element 310B up when the brake element is to be disengaged with the fishing line. Alternatively, the top of the brake element 310B may be attached to the flexible seal which will induce an upward pull on the brake element to disengage like the aforementioned spring.

FIG. 3C shows an embodiment in which the electro-mechanical device 311C and electronic circuitry 312C are located along side the brake element 310C rather than above the brake element 310C. A water proof seal 313C is observed that is oriented substantially perpendicular to the water surface rather than substantially parallel to the water surface (as observed in FIG. 3B). According to this approach, the interface 316C between the brake element 310C and the electro-mechanical device 311C moves left/right to engage/disengage the fishing line 301C. The mechanics of disengagement and the use of a flexible or rigid seal 313C may be implemented similarly as described above with respect to FIG. 3C. Again, if the mechanical interface 316C punches through the seal the region around the area where the interface 316C punches through should remain water proof.

FIG. 3D shows an embodiment in which the electronic circuitry 312D resides within the brake element 310D and the electro-mechanical device 311D resides outside the brake element 310D. According to this design, the electrical wiring 317D between the circuitry 312D and the electro-mechanical device 311D run through a water tight seal 313D. According to the design of FIG. 3D, springs 318D are fixed through the water tight seal 313D and push the brake element 310D downward to clamp the fishing line in its nominal state. A command to release the fishing line causes the electro-mechanical device 311D to pull a mechanical interface with the brake element 310D up. Like wiring 317D and springs 318D, the mechanical interface runs through the water tight seal 313D in a manner that preserves the seal.

FIG. 3E shows an embodiment in which both the electronic circuitry 312D and electro-mechanical device 311D reside within the brake element 310D. According to this design, springs 318E are fixed through the water tight seal 313E and push the brake element 310E downward to clamp the fishing line in its nominal state. A command to release the fishing line causes the electro-mechanical device 311E to pull the brake element 310E up.

Note that, in any of the above embodiments, the electro-mechanical device may be implemented with various types of actuators, or servo-motors. Moreover, in any of the embodiments above, the battery for the electrical circuit may be located in the same regions indicated in the figures where the electronic circuitry is shown. Alternatively, the battery may be located elsewhere. For instance, if the electronic circuitry is located outside the brake element the battery may be located inside the brake element. Alternatively, if the electronic circuitry is located inside the brake element, the battery may be located outside the brake element. In either case the wiring between the battery and the electronic circuiting may have to pass through a water tight seal.

FIG. 3F shows an approach where the electro-mechanical device 310F self distorts in order to accomplish the desired movement. In this case the electro-mechanical device 310F may be implemented with a polymer actuator or possibly a piezo-electric device. In the nominal state, the electro-mechanical device 310F is in a first state that corresponds to a shorter electro-mechanical device height. The shorter height causes the brake element 310F to clamp against the fishing line. When a command is received to release the fishing line a signal is sent to the electro-mechanical device that causes the device to distort to a taller height (observed in FIG. 3F). The taller height distortion lifts a brake element 310F so as to release the fishing line.

FIG. 3G shows an approach where the fishing line runs through a dual wheel channels 319, 310G. According to one embodiment, an entire wheel channel 310G acts as a brake element that, when the electro-mechanical device 311G presses the brake element wheel channel 310G against the other wheel channel 319, acts to prevent any run of the fishing line through the wheels and therefore keeps the hook depth constant. When the electro-mechanical device 311G slightly releases this pressure, the fishing line runs through the wheels so as to permit hook depth adjustment. In an alternate embodiment, the electro-mechanical device 311G is coupled to one or more brake elements (not shown) that act as a brake on the wheel(s). When the electro-mechanical device is in a first state, the brake element(s) are released allowing the wheels to turn and the fishing line to run. In a second state, the brake element(s) are engaged preventing the wheels from turning and therefore preventing any run of the fishing line. A water tight seal 313G protects the electro-mechanical device 311G and the electronic circuitry 312G from any water that may enter the bobber 301G.

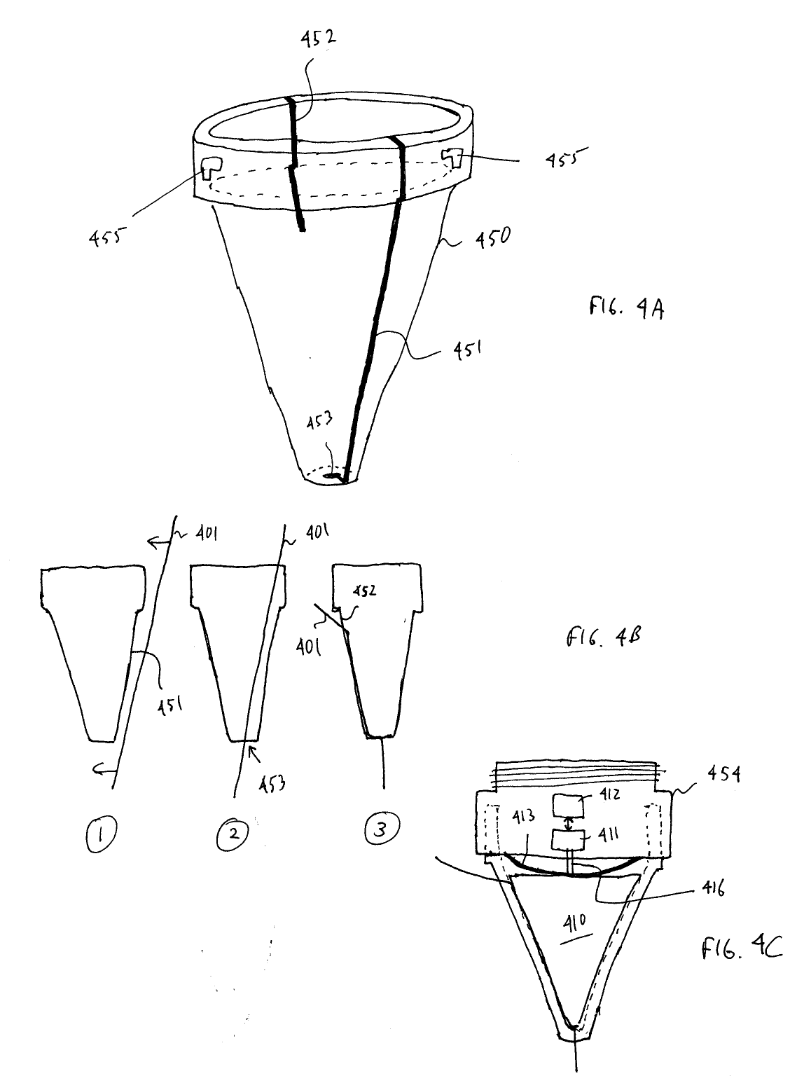

FIGS. 4A through 4C show a more detailed embodiment. According to this embodiment, as observed in FIG. 4A, a bottom part 450 of the bobber includes a full length slit opening 451 and a stub length slit opening 452. As observed in FIG. 4B, the fishing line is passed through (1=>2) the full length slit opening 451 so that the fishing line 401 flows from the bottom hole 453 of the bobber. Next, the fishing line 401 is next passed through (3) the stub length slit opening 452, and, as observed in FIG. 4C, a cap 454 is secured to the top of the bottom part 450. Here, the bottom part 450 may have threads or, as another example, safety cap like tabs 455 to secure a threaded or safety cap type seal between the bottom part 450 and the cap 454. Notably, when the cap 454 is secured to the bottom part 450, the fishing line cannot exit the stub slit 452 (because the cap 454 essentially closes off the top of the stub slit), and, therefore cannot exit the bottom part 450 through the full length slit 450 . Thus, the bottom part 450 has been properly threaded with the fishing line.

Each of the electronic circuitry and electro-mechanical devices 411, 412 may be within the cap or within the brake element 410 consistent with the discussions above with respect to FIG. 3. As observed in the particular example of FIG. 4C, the circuitry and electro-mechanical devices 411, 412 are within the cap 454. Assuming the electro-mechanical device 411 corresponds to an actuator, the actuator pushes/pulls a rod 416 that stems from the bottom of the cap.

In an embodiment, the brake element 410 is integrated with the cap 454 by way of a taught flexible sheath 413 that suspends the brake element 410. The nominal state of the actuator 411 is to have the rod 416 extended outward such that when the cap 454 is affixed to the top of the bottom part 450, the rod 416 pushes the brake element downward 410 such that it engages the fishing line. In doing so, the flexible sheath 413 is extended thereby inducing an upward tension on the brake element 410 that is overcome by the downward force of the activator rod 416. The activator rod, in this case, does not punch through the sheath which also acts as a water proof seal. Notably, the circuitry and electro-mechanical device 411, 412 may be embedded in the body of the (e.g., plastic) cap 454.

When a command is received to release the clamp on the fishing line the actuator rod 416 moves upward. The upward tension from the sheath 413 lifts the brake element 410 to free the fishing line. When a command is received to clamp the line, the actuator rod 416 pushes downward to return to its nominal state.

In an embodiment, the top of the cap 454 is threaded so that different types of bobber tops can be easily attached to the cap (e.g. a substantially circular bobber top, a bobber top designed to look like a floating log or stick, a bobber top designed to look like a lily pad, etc.).

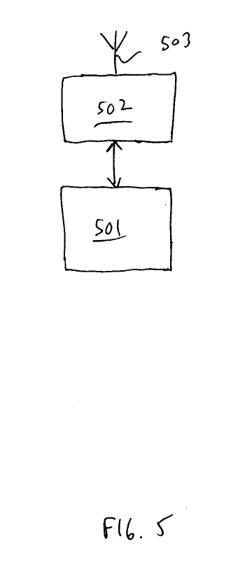

FIG. 5 shows an embodiment of the wireless circuitry which includes a control processor 501 of some kind (e.g., a hardwired state machine, a microprocessor that processes program code stored in memory, a microcontroller that processes program code stored in memory, etc.). The control processor 501 is coupled to wireless input/output (I/O) circuitry 502 that at least receives a wireless command and may even have the ability to wirelessly transmit an acknowledgment to a received wireless command. The wireless I/O circuitry 502 is coupled to an antenna 503. In various embodiments the antenna 503 should be above the water line so that it can receive wireless signals. As such, in one approach the antenna is positioned toward the top of the cap 454 or other part of the overall assembly designed to reside above the water line.

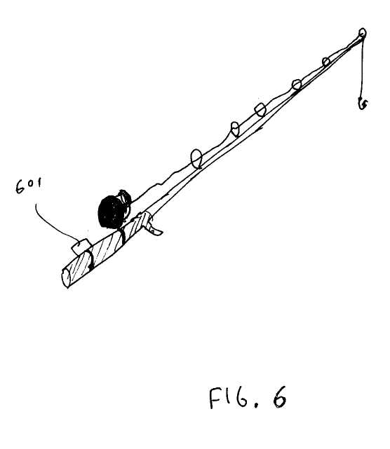

FIG. 6 shows a fishing pole with an integrated transmitter 601 for transmitting the open/close commands to the bobber. The circuitry of the transmitter may be very similar to the circuitry shown in FIG. 5 except that additional user interface features (e.g., buttons, keys, touch display) are coupled to control processor so the fisherman can cause the correct commands to be sent. In an embodiment the buttons/keys, either physical or displayed on a touch screen are labeled with the corresponding command (e.g., “open”, “close”). The I/O wireless circuitry at least includes the ability to send a command to the bobber and may have the ability to receive an acknowledgment to the command from the bobber.

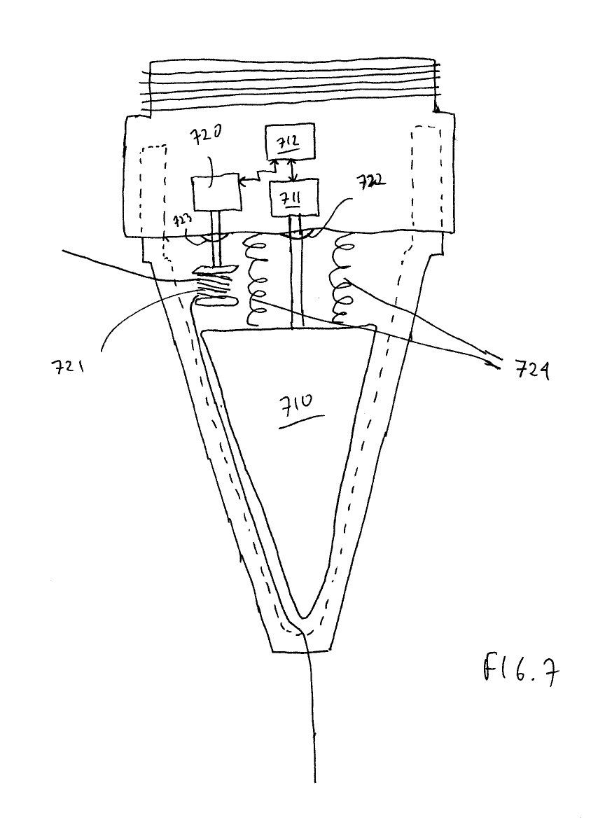

FIG. 7 shows an embodiment of a more sophisticated bobber that has the ability to receive and process wireless commands that specify a specific hook depth (e.g., “set hook depth to 4 feet”) and/or that specify a specific change in hook depth (e.g., “drop hook 1 foot” or “raise hook 1 foot”). The bobber assembly of FIG. 7 operates much as described above with respect to FIG. 4C with the exception that springs 724 act to provide the tension originally provided by the sheath 413 in FIG. 4C, water tight seals (e.g., smaller punched through sheaths 720, 722), a second electro-mechanical device 720 coupled to a spool 721 around which the fishing line is wound. In an embodiment, the second electro-mechanical device is a motor whose number of rotations can be precisely controlled with electronic signals. Here, the wireless command that sets a new depth setting or change in hook depth is received and processed by the control processor which determines the correct number of turns and rotational direction of the turns to satisfy the command. The number of turns and direction of turns is converted into an electronic signal by the central controller and presented to the second electro-mechanical device 720 which rotates the spool axis to effect the command. Conceivably, brake element 710 may be eliminated with the spool behaving as the brake element (e.g., the spool axis is prevented from turning by the second electro-mechanical device 720 thereby preventing a free run of the fishing line).

Notably, referring back to FIG. 6, the transmitter 601 may further include additional buttons (e.g., physical buttons or buttons or other features rendered on a graphical display) to send such commands including the ability to numerically specify the desired depth/change.

In an alternate embodiment, rather than a spool 721 having multiple turns of fishing line, instead, the spool is replaced by wheel around which the fishing line may be wound a few times, once, or even less (e.g., if tension is introduced between the fishing line and the wheel). Again, the wheel turns can be converted into fishing line run length as described above to at least measure a run of fishing line through the bobber. Alternatively or in combination, e.g., if tension is introduced between the wheel and the fishing line, the wheel can be driven by the second electro-mechanical device to control run length changes in the fishing outright.

Note also that embodiments of the present description may be implemented not only within a semiconductor chip but also within machine readable media. Thus, it is also to be understood that embodiments of this invention may be used as or to support a software program executed upon some form of processing core (such as the central controller discussed above) or otherwise implemented or realized upon or within a machine readable medium. A machine readable medium includes any mechanism for storing information in a form readable by a machine (e.g., a computer). For example, a machine readable medium includes read only memory (ROM); random access memory (RAM); magnetic disk storage media; optical storage media; flash memory devices; etc.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A fishing bobber, comprising:
electronic circuitry coupled to an electro-mechanical device, said electro-mechanical device to affect a depth of a hook beneath said bobber by inducing movement of a fishing line that is coupled to said hook and threaded through said bobber, said electronic circuitry comprising wireless receiver circuitry to receive a wireless command that causes said electro-mechanical device to take action in response thereto.

2. The fishing bobber of claim 1 further comprising a brake element mechanically coupled to said electro-mechanical device.

3. The fishing bobber of claim 2 wherein said fishing bobber comprises a flexible member coupled to said brake element to place said brake element in one of:
i) a state that clamps said fishing line to said bobber;
ii) a state that does not clamp said fishing line to said bobber.

4. The fishing bobber of claim 1 further comprising a water tight seal between said electronic circuitry and an opening in said bobber in which water may flow.

5. The fishing bobber of claim 1 further comprising a water tight seal between said electro-mechanical device and an opening in said bobber through which water may flow.

6. The fishing bobber of claim 1 wherein said electro-mechanical device is an actuator.

7. The fishing bobber of claim 6 wherein said actuator is a polymer actuator.

8. The fishing bobber of claim 1 wherein said electro-mechanical device is a servo-motor.

9. The fishing bobber of claim 1 further comprising a second electro-mechanical device.

10. The fishing bobber of claim 1 wherein said electronic circuitry further comprises a central controller coupled to said wireless receiver circuitry.

11. The fishing bobber of claim 1 further comprises an antenna coupled to said wireless receiver circuitry, said antenna positioned to be above a water line when said bobber is floating in water.

12. The fishing bobber of claim 1 further comprising an interface to which different bobber style types may be attached.

13. A fishing pole comprising:
a transmitter comprising electronic circuitry to transmit a wireless command to a fishing bobber.
